(19) United States
(12) Patent Application Publication
(10) Pub. No.: US 2004/0084258 A1
(43) Pub. Date: May 6, 2004

(54) Disk brake pad

(76) Inventors: Hiroyuki Fujikawa, Osaka-city (JP); Yoshihide Yamada, Toyota-city (JP); Yukio Shimokawa, Toyota-city (JP)

Correspondence Address: POSZ & BETHARDS, PLC, 11250 ROGER BACON DRIVE, SUITE 10, RESTON, VA, 20190, US

(21) Appl. No.: 10/673,290

(22) Filed: Sep. 30, 2003

(30) Foreign Application Priority Data
Oct. 3, 2002 (JP) 2002-291209

(51) Int. Cl. F16D 65/00

(52) U.S. Cl. 188/73.1

(57) ABSTRACT

A disk brake pad for controlling rotation of a rotating disk by being pressed against the disk, is provided with a first friction member that is disposed at a leading side portion that is an inward-rotating side of the disk; a second friction member, which has a friction coefficient and a Young's modulus that are large as compared to those of the first friction member and which is easily worn, that is disposed at a trailing side portion that is an outward-rotating side of the disk. Further, on a surface that contacts with the disk, the first friction member protrudes further than the second friction member. In addition, a slit is provided between the first friction member and the second friction member; both of the friction members and are partitioned by the slit so as to be spaced apart from each other.

### CROSS REFERENCE TO RELATED APPLICATION

This application is based upon and claims the benefit of Japanese Patent Application No. 2002-291209 filed on Oct. 3, 2002, the content of which are incorporated herein by reference.

### FIELD OF THE INVENTION

The invention relates to a disk brake pad that controls rotation of a rotating disk by being pushed against the disk.

### BACKGROUND OF THE INVENTION

Generally, this type of disk brake pad is formed by mixing a fiber material such as organic fiber or non-organic fiber, a powdered material such as a friction regulating agent or a filler, and a binder resin such as phenol resin; and then thermoforming the mixture thereof.

With this type of disk brake pad, brake effectiveness improves as the friction coefficient of the pad becomes larger. However, on the other hand, brake noise is more likely to be generated. In contrast to this, as the friction coefficient becomes smaller, brake noise is inhibited, but brake effectiveness worsens.

To address this, conventionally, art has been disclosed which attempts to simultaneously achieve a desirable brake noise characteristic and a desirable brake effectiveness characteristic through provision of a plurality of individual friction members having various friction properties (for an example refer to Japanese Patent Laid-Open Publication No. 09-112606 (Page 4, FIGS. 1 and 2.)). However, this art has the drawback that there are limitations to how the plurality of individual friction members may be arranged in order to achieve the desired characteristics.

In response to this, further conventional art (for an example refer to Japanese Patent Laid-Open Publication No. 2000-120738 (Page 3, FIG. 1)) has been proposed in which a plurality of individual friction members are optimally positioned on a single disk brake pad. In this art, friction members having different degrees of hardness are disposed at a leading side portion that is a disk inward-rotating side and a trailing side portion that is a disk outward-rotating side.

Accordingly, the hardness of the leading side friction member is small and the hardness of the trailing side friction member is high. Thus, it is possible for a contact pressure of the trailing side friction member to be made larger than a contact pressure of the leading side friction member. Therefore, oscillation of the disk brake pad on the trailing side is inhibited, and it is possible to inhibit the generation of brake noise.

However, this configuration, in which brake members with different degrees of hardness are disposed on leading and trailing sides of a single disk brake pad, does not offer sufficient benefits in terms of brake effectiveness. Moreover, abraded particles from the leading side friction member with low hardness are transferred in a disk rotation direction to the trailing side. Accordingly, a problem occurs in which the surface friction characteristics of the trailing side become substantially the same as those of the leading side.

Moreover, conventionally, art has been proposed in which there is a slit between a leading side friction member and a trailing side friction member (refer for example to Japan Institute of Invention and Innovation, Journal of Technical Disclosure No. 2001-5790). Accordingly, abraded particles from the leading side friction member are removed via the slit, and it is possible to inhibit transfer of the abraded particles from the leading side friction member to the trailing side.

However, as a result of investigations carried out by the inventors, it has become apparent that with a construction in which a slit is simply provided between the two friction member on both sides, in the case that the width of the slit is narrow, abraded particles become clogged in the slit. As a result, discharge is inhibited.

### SUMMARY OF THE INVENTION

In view of the foregoing situation, it is an object of the present invention to provide a disk brake pad that simultaneously achieves a desirable brake noise characteristic and a desirable brake effectiveness characteristic in an appropriate manner.

In order to realize the above object, in the invention as described in a first aspect of the invention, a disk brake pad for controlling rotation of a rotating disk by being pressed against the disk, includes: a first friction member that is disposed at a leading side portion that is an inward-rotating side of the disk; and a second friction member, which has a friction coefficient and a Young's modulus that are large as compared to those of the first friction member, and which is easily worn, that is disposed at a trailing side portion that is an outward-rotating side of the disk. Generally, with disk brake pads, brake noise is more easily generated when the pressure (pad pressing force) at which the pad is pressed against the disk is small. Given this point, in the first aspect of the invention, since the first friction member protrudes further than the second friction member on the surface that contacts with the disk, at times when pad pressing force is low and brake noise is easily generated, generation of brake noise is inhibited by the first friction member, which has the comparatively low friction coefficient, coming into contact with the disk such that wear occurs.

On the other hand, when brake effectiveness is required at times of high pad pressing force, since the Young's modulus of the first friction member is smaller than the Young's modulus of the second friction member, the first friction member is compressed by the high pad pressing force, and wear occurs in a state in which the second friction member, which has the comparatively large friction coefficient, is in contact with the disk. Thus, sufficient brake effectiveness can be obtained.

In order to realize brake noise inhibition and sufficient brake effectiveness through the difference of the friction coefficients of the first friction member and the second friction member in this way, it has been found that it is sufficient that the difference of the friction coefficients of the first and second friction members is 0.05 or more.

Further, since the first friction member of the leading side is less easily worn than the second friction member of the trailing side, even if wear of the overall disk brake pad progresses, it is possible to maintain the structure in which the first friction member protrudes further than the second friction member.

According to a second aspect of the invention, a slit is provided between the first friction member and the second friction member, both of the friction members being partitioned by the slit so as to be spaced apart from each other.

Thus abraded particles from the first friction member of the leading side are discharged from the slit, and transfer to the second friction member of the trailing side is inhibited.

In addition, in order to appropriately realize the effects of the slit, it has been found that it is sufficient that the width of the slit is 1 mm or more.

In this way, maintenance of the protruding structure of the first friction member, and inhibition of transfer of the abraded particles of the first friction member are realized. Accordingly, it is possible to achieve, over a long period, realization of the above described brake noise inhibition and sufficient brake effectiveness.

As described above, according to the invention, it is possible to simultaneously realize the desirable brake noise characteristic and the desirable brake effectiveness characteristic in an appropriate manner.

### BRIEF DESCRIPTION OF THE DRAWINGS

Other objects, features and advantages of the present invention will be understood more fully from the following detailed description made with reference to the accompanying drawings. In the drawings:

FIG. 1 shows a configuration of a disk brake pad according to an embodiment of the invention; FIG. 1A is a plan view, and FIG. 1B is a cross-sectional view taken along a line A-A within FIG. 1A;

FIG. 2 is a perspective view showing a configuration of a die used in a manufacturing method of the disk brake pad according to the above embodiment;

FIG. 3 is a table showing various examples of the disk brake pad in which friction coefficients and Young's moduli of a first friction member and a second friction member, and a width of a slit have been changed; and

FIG. 4 is a table showing investigation result for brake noise characteristics and brake effectiveness characteristics for the examples illustrated in FIG. 3.

### DETAILED DESCRIPTION OF THE PREFERRED EMBODIMENTS

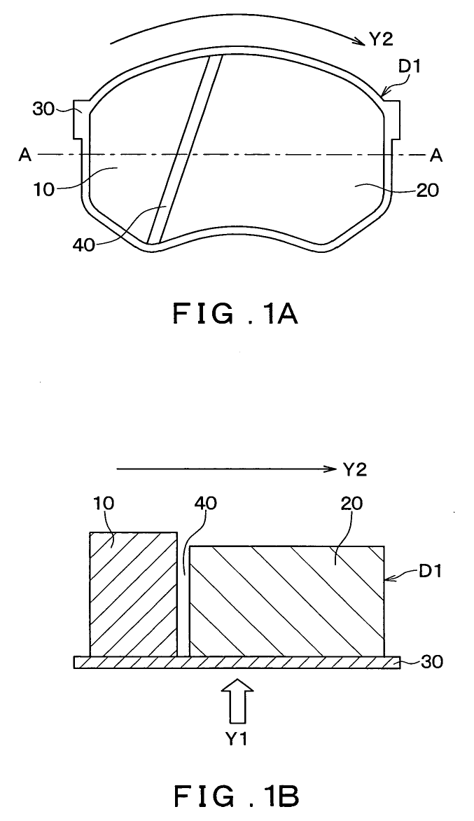

The present invention will be described further with reference to various embodiments in the drawings. FIG. 1A and 1B show a configuration of a disk brake pad according to an embodiment of the invention; FIG. 1A is a schematic plan view, and FIG. 1B is a schematic cross-sectional view along a line A-A within FIG. 1A.

In FIG. 1A, a surface that is pressed toward a disk (disk rotor, not shown) of a disk brake pad D1 is shown from the front. In addition, the disk brake pad D1 is subject to pressure (hereinafter referred to as a “pad pressing force”) from a piston, or the like, not shown, in the manner shown by the white arrow Y1 in FIG. 1B, such that it is pressed to the disk.

Further, in FIG. 1, a rotation direction of the disk is shown by the arrow Y2. Rotation of the disk is controlled by pressing the disk brake pad D1 against the rotating disk in this manner.

The disk brake pad D1 is configured such that a first friction member 10 is disposed at a leading side portion that is an inward-rotating side of the disk; and a second friction member 20 is disposed at a trailing side that is an outward-rotating side of the disk. In this way, the first friction member 10 and the second friction member 20 are disposed along a sliding direction in this order.

Note that the first friction member 10 and the second friction member 20 have the following differences with regard to friction coefficients, Young's moduli, and wearability. With regard to their friction coefficients and Young's moduli, the first friction member 10 is smaller (low), and the second friction member 20 is larger (high). In this case, a difference in the friction coefficients of the first friction member 10 and the second friction member 20 is 0.05 or more.

Moreover, with regard to wearability, while the first friction member 10 wears less easily, the second friction member 20 wears more easily. In other words, the first friction member 10 on the leading side, as compared to the second friction member 20 on the trailing side, is more easily able to slide and less easily worn, with respect to the disk. Further, it is more easily subject to distortion deformation when pressed against the disk.

These first and second friction members 10 and 20, are formed by mixing a fiber material such as organic fiber, non-organic fiber, or metal fiber; a powdered material such as a friction regulation agent or a filler; and a binder resin such as phenol resin, which are used in a normal brake pad; and then thermoforming the mixture thereof.

For example, as the fiber material, aramid fiber, copper fiber, steel fiber, and the like, may be suggested; as the friction regulating agent or the filler, graphite, cashew dust, aluminum, calcium hydroxide, mica, barium sulfate, and so on, may be suggested.

When thermoforming the friction members using these types of materials, control of the friction coefficients is possible by, for example, adjusting the composition of comparatively hard materials such as steel fiber and aluminum, and the like. Moreover, control of the Young's moduli is possible by adjusting the composition of comparatively soft materials such as aramid fiber, and the like.

Further, with regard to wearability, it is possible to make wear less liable to occur by, for example, increasing the composition of fibrous raw materials, thus increasing the bonding strength within the friction members. By using a method such as this, it is possible to control the friction coefficients, the Young's moduli, and wearability.

Moreover, as shown in FIG. 1B, the first friction member 10 protrudes further than the second friction member 20 from the surface that contacts with the disk. A step height of both of the friction members 10 and 20 at the protrusion can be set, specifically, to approx. a few tens of μm (for example, approx. 30 μm). In addition, both of these friction members 10 and 20 are bonded to a backing metal 30 at a side opposite to the face that contacts with the disk, and are fixedly maintained by this backing metal 30.

Moreover, a slit 40 is provided in the disk brake pad D1 of the embodiment as a space between the first friction member 10 and the second friction member 20; the friction members 10 and 20 are spaced apart from each other by the slit 40. Note that the width of the slit 40 is 1 mm or more.

Further, it is sufficient that the slit 40 is formed such that it opens toward the surface that contacts the disk. A bottom portion of the slit 40, namely, a portion in the vicinity of the backing metal 30, may be formed such that the first friction member 10 and the second friction member 20 are connected.

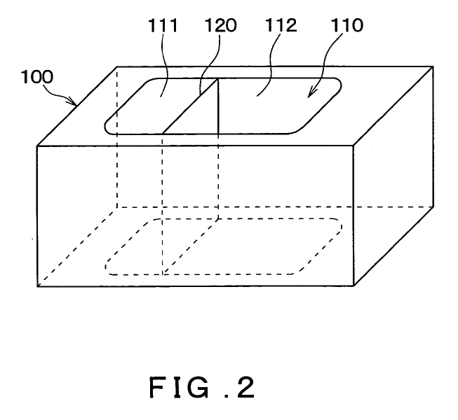

Next, a manufacturing method for the above described disk brake pad D1 will be explained. FIG. 2 is a perspective view showing a configuration of a die 100 used in this manufacturing method.

A cavity 110 that determines the external shape of the first and second friction members 10 and 20 is formed in this die 100. Within this cavity 110, a partition 120 for forming the slit 40 is provided. The cavity 110 is partitioned into a cavity 110 for forming the first friction member and a cavity 112 for forming the second friction member, by this partition 120.

First, mixtures for the first friction member 10 and the second friction member 20, respectively, are prepared that are formed by mixing the fiber material that is organic, non-organic, metal, or the like; the powdered material such as the friction regulation agent or the filler; and the binder resin such as the phenol resin. In addition, the mixture for the first friction member 10 is poured into the cavity 111 for forming the first friction member and the mixture for the second friction member 20 is poured into the cavity 112 for forming the second friction member.

Following this, the backing metal 30 is attached to the die so as to cover the cavity 110. At this time, adhesive for bonding with each of the friction members 10 and 20 is applied to the backing metal 30. The backing metal 30 and the adhesive in this state are pressed from the opposite side of the backing metal 30, and following this, heating is conducted for hardening, and thus the molded object is formed.

The molded object formed in this manner is removed from the die 100; next, a polishing process is executed. In this polishing, the surface of the molded object that contacts with the disk is polished in order to improve evenness so that it is able to function as a brake pad.

During this polishing, since the second friction member 20 has greater wear-susceptibility characteristic than the first friction member 10, a wear amount of the second friction member 20 caused by polishing is larger. Accordingly, as shown in FIG. 1B described above, shape formation occurs such that the first friction member 10 protrudes further than the second friction member 20 on the surface that contacts with the disk. When this polishing is finished, the described disk brake pad D1 is formed.

Next, an explanation of the operational effects of the described disk brake pad D1 will be given. Generally speaking, with disk brake pads, brake noise is more easily generated when the pressure (pad pressing force) at which the pad is pressed against the disk is small.

In this embodiment, however, since the first friction member 10 protrudes further than the second friction member 20 on the surface that contacts with the disk, at times when pad pressing force is low and brake noise is easily generated, generation of brake noise is inhibited by the first friction member 10, which has the comparatively low friction coefficient, coming into contact with the disk such that wear occurs.

On the other hand, when high pad pressing force is applied when brake effectiveness is required, since the Young's modulus of the first friction member 10 is smaller than the Young's modulus of the second friction member 20, the first friction member 10 is compressed by the high pad pressing force, and wear occurs in a state in which the second friction member 20, which has the comparatively large friction coefficient, is in contact with the disk. Thus, sufficient brake effectiveness can be obtained. This realization of brake noise inhibition and sufficient brake effectiveness is made possible by setting the difference of the friction coefficients of both of the friction members 10 and 20 to 0.05 or more.

Further, since the first friction member 10 of the leading side is less easily worn than the second friction member 20 of the trailing side, even if wear of the overall disk brake pad D1 progresses, it is possible to maintain the structure in which the first friction member 10 protrudes further than the second friction member 20.

Moreover, in this embodiment, the slit 40 is provided between the first friction member 10 and the second friction member 20; the friction members 10 and 20 are partitioned so as to be spaced apart from each other by the slit 40. Thus abraded particles from the first friction member 10 of the leading side are discharged from the slit 40.

Accordingly, transfer of the abraded particles from the first friction member 10 to the second friction member 20 of the trailing side is inhibited (namely, the abraded particles being transferred and becoming adhered to the surface of the second friction member 20, thus causing the friction characteristic of the second friction member 20 to become the same as that of the first friction member 10 from an external point of view). In addition, inhibition of this transfer is realized as a result of the width of the slit 40 being set at 1 mm or more.

As described above, realization is achieved of: disposal of both of the friction members 10 and 20 having different characteristics in optimal positions for realizing the desirable brake noise characteristic and the desirable brake effectiveness characteristic; maintenance of the protruding structure of the first friction member; and, inhibition of transfer of abraded particles of the first friction member. Accordingly, it is possible to achieve, over a long period, realization of the above described brake noise inhibition and sufficient brake effectiveness.

Accordingly, with the disk brake pad D1 of the embodiment, it is possible to simultaneously realize the brake noise characteristic and the brake effectiveness characteristic in a satisfactory manner.

Further, as described above, the difference in the friction coefficients of the first friction member 10 and the second friction member 20 is set to 0.05 or more, and the width of the slit 40 is set to 1 mm or more. These settings were made based on investigation results as described below.

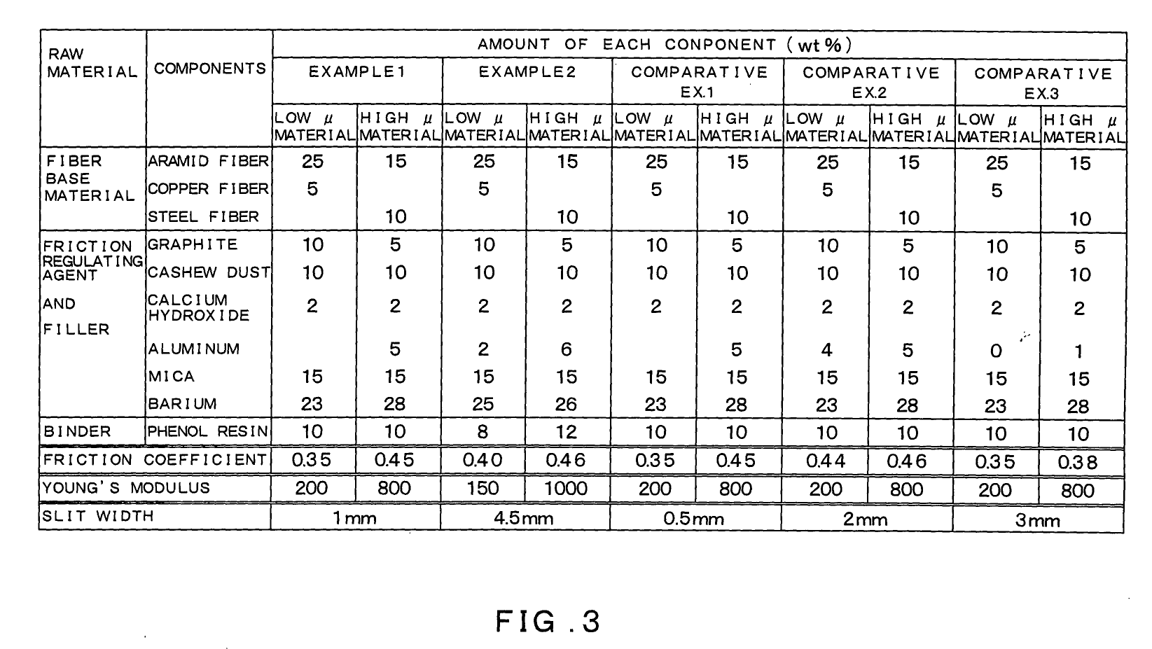

FIG. 3 is a table showing various examples of the disk brake pad in which the friction coefficients and the Young's moduli of both of the friction members 10 and 20, and the width of the slit 40 have been changed. Note that, in FIG. 3, examples 1 and 2, which are examples according to the embodiment, and comparative examples 1 to 3 are shown. The first friction member 10 with the comparatively low friction coefficient is shown as “low μ material” and the second friction member 20 with the comparatively high friction coefficient is shown as “high μ material”.

Moreover, with regard to the raw materials of each example, aramid fiber, copper fiber and steel fiber are used as the components of the fiber base material; graphite, cashew dust, calcium hydroxide, aluminum, mica and barium sulfate are used as the components of the friction regulating agent and the filler; and phenol resin is used as the component of the binder. In FIG. 3, the amount of each component of the low μ material and the high μ material are shown using units of wt %.

With regard to each example, the brake pad is produced in the following manner. A raw material mixture (mixture) is obtained by mixing the raw materials evenly during 5 minutes of drying using a Eirich mixer. Thermoforming is conducted by placing each raw material mixture for 10 minutes within the die 100 heated to 160° C., and then pressurized at 200 kg/cm². Following this, the molded object is hardened at 230° C. for 3 hours, and following this, production is executed using the polishing process.

Further, the friction coefficients shown in FIG. 3 were derived by measurements using a dynamometer in accordance with JASO C406. For each example shown in FIG. 3, control of the friction coefficients is executed by adjusting the composition of steel fiber and aluminum; and control of the Young's moduli is executed by adjusting the composition of aramid fiber; accordingly, for each example, the friction coefficient and the Young's modulus for the low μ material are smaller than that for the high μ material.

In addition, with regard to wearability, by increasing the composition of the fiber material in the low μ material such that it is higher than that of the high μ material, the low μ material is made so as to be less easily wearable than the high μ material. In actuality, for each example, an investigation was conducted of wear amount after repeating braking a 1000 times at a test temperature of 100° C. using a dynamometer; for all of the examples, the wear amount of the low μ material was lower than that of the high μ material.

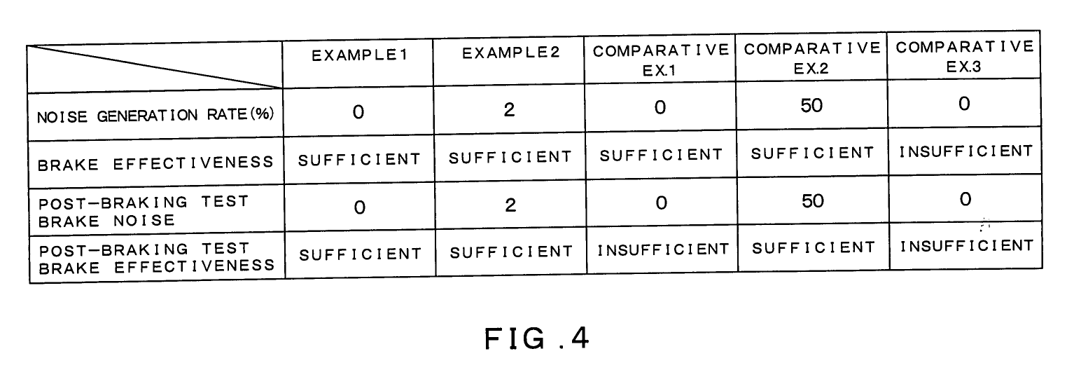

Moreover, FIG. 4 shows investigation results for, as the brake noise characteristic, “brake noise generation rate (%), and “brake effectiveness”, “post-braking test brake noise”, and “post-braking test brake effectiveness”, for each example shown in FIG. 3.

The brake noise generation rate is a percentage value obtained by dividing a brake noise frequency by a total braking number, in a test using a dynamometer. Moreover, the brake effectiveness was confirmed using an actual vehicle test. Moreover, for the post-braking test brake noise and brake effectiveness, braking was repeated 500 times at a temperature of 250° C. using a dynamometer, and after this, the brake noise generation rate was derived and the brake effectiveness was measured.

From FIG. 3 and FIG. 4, first, when the width of the slit 40 is small at 0.5 mm (refer to comparative example 1), abraded particles of the low μ material (the first friction member) are transferred to the high μ material (the second friction member), and it is apparent that the post-braking test brake effectiveness is reduced.

Moreover, when the difference of the friction coefficients of the low μ material and high μ material is small at 0.02 or 0.03, worsening of brake noise and reduction in brake effectiveness occur (refer to comparative examples 1 and 2). This is because this difference of the friction coefficients between the low μ material and the high μ material is not larger enough to show the desirable characteristics clearly.

In contrast to this, in examples 1 and 2, the difference of the friction coefficients of the low μ material and the high μ material is 0.05 or more, and the width of the slit 40 is 1 mm or more; accordingly, initial and post-braking test brake noise and brake effectiveness are all improved. Further, in example form 2, the above difference of the friction coefficients is 0.06 or more; however, it has been confirmed that if the difference of the friction coefficients is 0.05 or more, it is possible to attain similar improved results.

Comparison and analysis of the results for each example shown in FIG. 3 and FIG. 4 show that it is necessary for the difference of the friction coefficients of the first friction member 10 and the second friction member 20 to be 0.05 or more, and that it is necessary for the width of the slit 40 to be 1 mm or more.

Moreover, with regard to the forming method of the slit 40, the invention is not limited to the above described method using a die with a partition. It is possible to form the molded object with the first and second friction members 10 and 20 being stuck together, and after this, cutting out and removing an interface section of the first and second friction members 10 and 20. The gap created by removing this section constitutes the slit 40.

While the above description is of the preferred embodiments of the present invention, it should be appreciated that the invention may be modified, altered, or varied without deviating from the scope and fair meaning of the following claims.

What is claimed is:

1. A disk brake pad for controlling rotation of a rotating disk by being pressed against the disk, comprising:
a first friction member disposed at a leading side portion that is an inward-rotating side of the disk;
a second friction member, which has a friction coefficient and a Young's modulus that are large as compared to those of the first friction member, and which is easily worn, disposed at a trailing side portion that is an outward-rotating side of the disk.

2. The disk brake pad according to claim 1, wherein the first friction member being disposed so as to protrude further than the second friction member from a surface which contacts with the disk.

3. The disk brake pad according to claim 2, wherein a difference in the friction coefficients of the first friction member and the second friction member is 0.05 or more.

4. The disk brake pad according to claim 3, further comprising a slit being provided between the first friction member and the second friction member,
wherein both of the friction members being partitioned by the slit so as to be spaced apart from each other.

5. The disk brake pad according to claim 4, wherein a width of the slit is 1 mm or more.

6. The disk brake pad according to claim 2, further comprising a slit being provided between the first friction member and the second friction member,
wherein both of the friction members being partitioned by the slit so as to be spaced apart from each other.

7. The disk brake pad according to claim 6, wherein a width of the slit is 1 mm or more.

8. A disk brake pad for controlling rotation of a rotating disk by being pressed against the disk, comprising:
a first friction member disposed at a leading side portion that is an inward-rotating side of the disk;
a second friction member, which has a friction coefficient and a Young's modulus that are large as compared to those of the first friction member, and which is easily worn, disposed at a trailing side portion that is an outward-rotating side of the disk,
the first friction member being disposed so as to protrude further than the second friction member from a surface which contacts with the disk;
a slit being provided between the first friction member and the second friction member, both of the friction members being partitioned by the slit so as to be spaced apart from each other; wherein,
a difference in the friction coefficients of the first friction member and the second friction member is 0.05 or more, and a width of the slit is 1 mm or more.
